(19) United States
(12) Patent Application Publication
(10) Pub. No.: US 2009/0091292 A1
(43) Pub. Date: Apr. 9, 2009

(54) MOTOR CYCLE CELL PHONE POWER ADAPTER CHARGING SYSTEM

(75) Inventors: Kelly Nippear, Roseville, CA (US); Max Hultberg, Roseville, CA (US)

Correspondence Address: BULLIVANT HOUSER BAILEY PC, 1415 L STREET, SUITE 1000, SACRAMENTO, CA, 95814, US

(73) Assignee: Brookshire Innovations, LLC, Roseville, CA (US)

(21) Appl. No.: 12/245,594

(22) Filed: Oct. 3, 2008

Related U.S. Application Data
(60) Provisional application No. 60/977,428, filed on Oct. 4, 2007.

(51) Int. Cl. H02J 7/00; H02J 7/02

(52) U.S. Cl. 320/111; 320/107

(57) ABSTRACT

The invention provides a portable power adaptor charging system and kit comprising wire connectors having specialized ends to create a variety of configurations for charging batteries and consumer electronic devices using motorcycles and other recreational vehicles not equipped with traditional cigarette lighter sockets. The invention provides a portable power adaptor charging system comprising (a) at least one wire having first and second ends; (b) the first end having at least one double-pin quick connect socket; (c) the second end having at least one terminal to connect to a power source; and (d) the wire having an in-line fuse and fuse housing.

### REFERENCE TO RELATED APPLICATION

This application claims the benefit of U.S. Provisional Patent Application No. 60/977,428, filed Oct. 4, 2007, the complete disclosure of which is incorporated herein, in the entirety.

### BACKGROUND OF THE INVENTION

1. Field of the Invention

This invention describes a system for charging cellular telephones and other consumer electronics for use with motorcycles and other recreational vehicles that do not have traditional cigarette lighters installed.

Within the past decade, cellular telephones have become increasingly popular devices for enabling mobile telecommunications without the need to rely on pay telephones or to find a telephone in the nearby vicinity. Since cellular telephones are intended to be fully portable, it is necessary to charge the telephone's battery on a regular basis to provide the telephone with power for the frequent instances when a power outlet is not nearby or regularly accessible.

The claimed power adapter charging system is a unique apparatus for charging cell phones and other electronic devices that require a power socket adapter but were not OEM installed. This charging system satisfies a need in the marketplace to allow flexibility in a charging system for motorcycles and recreational vehicles that do not have a standard cigarette lighter outlet. The claimed charging system may also be utilized in a kit to provide a variety of different connection configurations to solve a multitude of charging needs and uses.

2. Description of Related Art

Over the years, cellular telephone technology has become increasingly advanced and has adapted the cellular telephones for plugging into a car's cigarette lighter as a renewable power source. However, that leaves motorcycles, ATVs, snowmobiles, Jet Skis, and Scooters which do not have cigarette lighters installed, without a way to charge cellular telephones.

None of the prior approaches have been able to provide a complete system for use in charging and recharging from a motorcycle or other recreational vehicle power system.

### SUMMARY OF THE INVENTION

This claimed portable power adaptor charging system and kit comprising wire connectors having specialized ends to create a variety of configurations for charging batteries and consumer electronic devices from motorcycles and other recreation vehicles.

The invention provides a portable power adaptor charging system comprising (a) at least one wire having first and second ends; (b) the first end having at least one double-pin quick connect socket; (c) the second end having at least one terminal to connect to a power source; and (d) the wire having an in-line fuse and fuse housing.

In one embodiment, a weather proof cap for the in-line fuse and fuse housing is attached to the wire.

In another embodiment, a weather proof cap for at least one double-pin quick connect socket is attached to the wire.

The invention provides two metal rings to connect to a 12 volt battery.

In another embodiment, two metal clips are used to connect to a 12 volt battery.

The invention provides a connector having at least two double-pin connector sockets.

In another embodiment, the invention provides for an end having a 12 volt power adaptor socket.

In another embodiment, the invention provides for an end having with at least one 12 volt power adaptor socket having a USB port.

The invention further provides a second end comprising an AC/DC wall plug.

This invention also provides a portable power charging kit comprising three or more components selected from the group of components consisting of (a) a connecting component having a first end with two metal clip connectors for electrical connection to a battery and a second end having at least one double-pin quick connect socket; (b) a connecting component having at least one double-pin quick connect socket at a first end, an in-line fuse, and at least two metal terminals at the second end for connection to a battery; (c) a connecting component having at least two double-pin quick connect sockets at a first end, an in-line fuse and fuse housing, and at least two metal terminals at the second end to connect to a battery; (d) a connecting component having a double-pin quick connect first end, and a double-pin quick connect second end; (e) a connecting component having a double-pin quick connect first end, and a 12 volt power adaptor socket at a second end; (f) a connecting component having a double-pin quick connect first end, and a second comprising a 12 volt power adaptor socket and a USB port; and, (g) a connecting component having a double-pin quick connect first end, and an AC/DC wall plug at a second end.

The invention also contemplates a portable motorcycle battery charging system comprising (a) a first connecting component having a first end with two metal clips to connect to a battery and a second end with at least one double-pin quick connect socket, and; (b) a second connecting component having a double-pin quick connect first end, an in-line fuse and fuse housing, and at least two metal terminals at the second end to connect to a battery. The portable motorcycle charging system further provides (c) a third connecting component having a wire having first and second ends with double-pin quick connect sockets at each end.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 shows a power adapter charging harness.

FIG. 2A shows a full view of the unconnected power adapter charging system.

FIG. 2B shows a full view of the connected double-pin quick connect sockets.

FIG. 3 shows a power adapter “Y” charging harness.

FIG. 4 shows a full view of the power adapter charging system with “Y” harness attached and the ability to connect a second adapter such as the 12 volt power adapter socket/USB port, as depicted.

FIG. 5 shows the “Y” harness attached to battery.

FIG. 6A shows the 12 volt power adapter socket with the double-pin quick connect socket.

FIG. 6B shows a front view of the 12 volt power adapter socket.

FIG. 7A shows a front view of the 12 volt power adapter socket/USB port having the double-pin quick connect socket.

FIG. 7B shows a perspective three-dimensional view of the 12 volt power adaptor socket/USB port.

FIG. 8A shows a front view of the bike-to-bike in-line jumper cable with double-pin quick connects.

FIG. 8B shows a top view of the double-pin quick connect socket.

FIG. 9 shows the 12 volt battery wall charger with double-pin quick connect socket.

FIG. 10 shows the battery terminal clips for the power adapter charging harness

FIG. 11 shows the complete power adapter charging kit with the different embodiments for adapting to consumer electronic devices.

### DETAILED DESCRIPTION OF THE INVENTION

The present invention provides a unique and novel system designed for motorcycles and recreational vehicles to charge consumer electronic devices and to charge and/or jump start a vehicle battery.

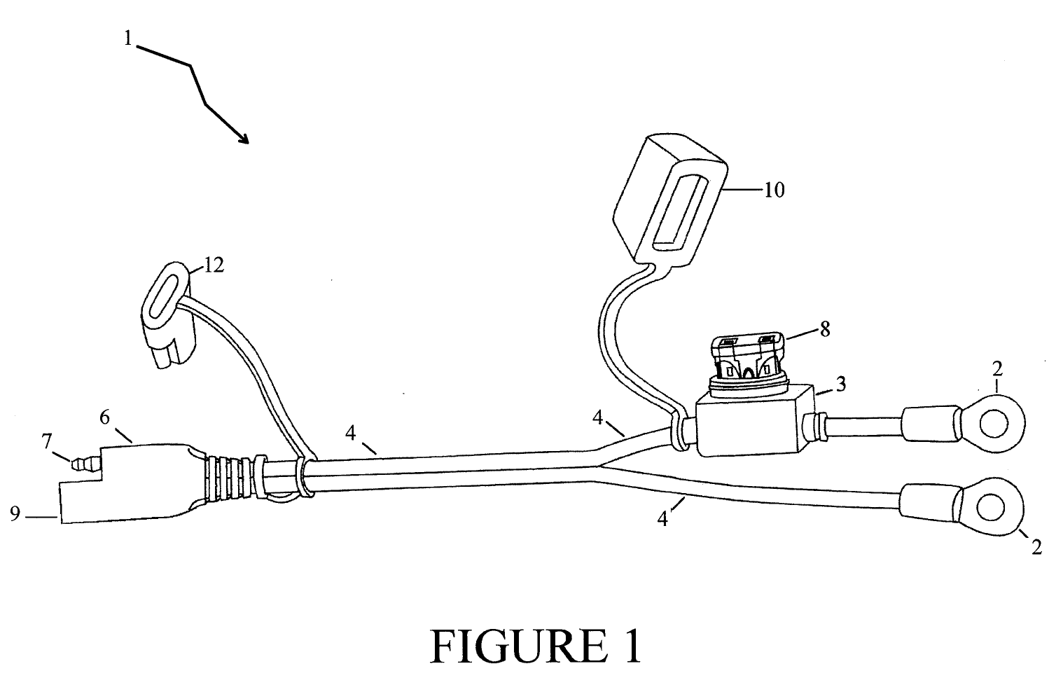

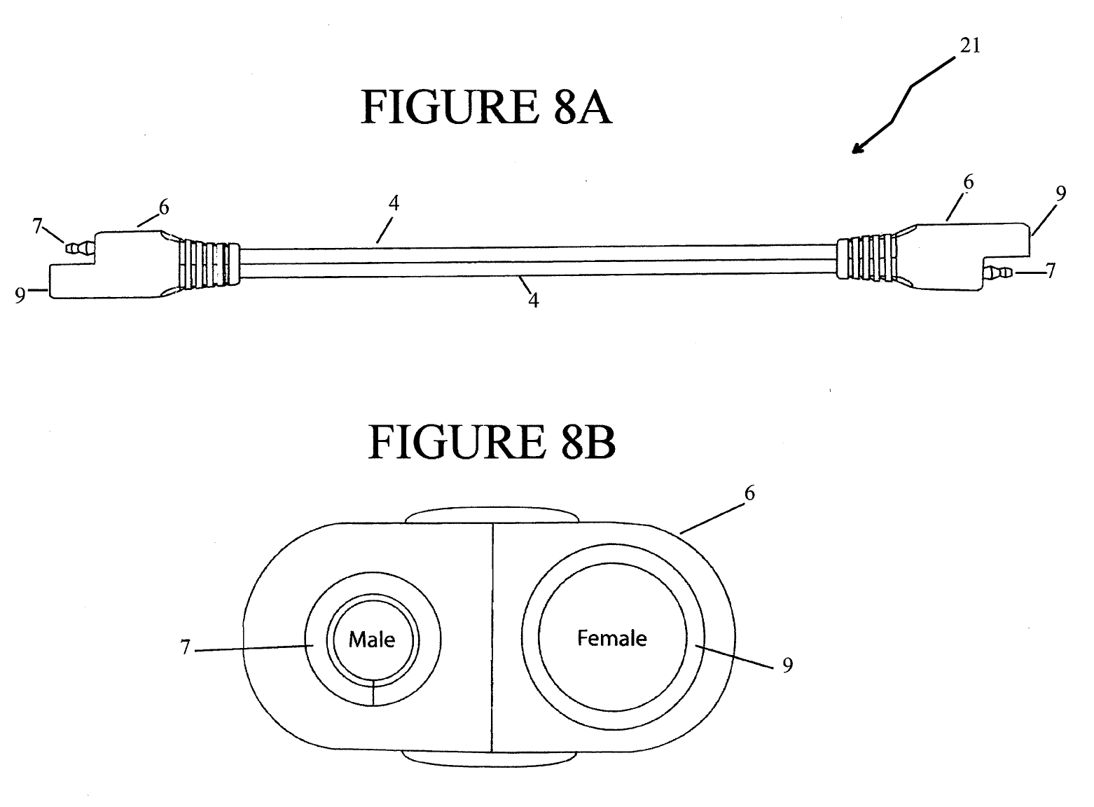

FIG. 1 identifies the power adapter charging harness 1. The power adapting charging harness 1 comprises an in-line fuse holder 3 with a double-pin quick connect socket 6 at the connecting end. In-line fuse holder 3 contains a 15 volt fuse 8 to prevent any power surges through the system that may damage cell phones or other electronic devices connected to the system. The in-line fuse 8 may be covered with a weather proof cap 10 attached to the power adapting charging harness 1 wire 4. The double-pin quick connect socket 6 may also be covered with a weather proof cap 12 attached to the power adapting charging harness 1 wire 4. The double-pin quick connect socket 6 further comprises male 7 and female 9 connection points. (FIG. 8B.) The terminal end of the harness comprises two ⅜ inch or 1 inch metal ring terminals 2 marked in red for the positive (+) terminal of the battery and black for the negative (−) terminal of the battery. The metal rings 2 enable the power adapting harness 1 connect to any 12 volt battery. The wire connector components 4 may be composed of 12-gauge, 14-gauge, 16-gauge, or 18-gauge wire. The connecting wire 4 may be between 2 feet and 4 feet in length.

The double-pin quick connect socket 6 allows the power adapting harness 1 to receive a variety of adapting components that can connect to numerous consumer electronic devices.

The 15-amp fuse 8 prevents any power surges through the system that may damage a cell phone or any other electrical device that may be connected to it such as a global positioning system (GPS), laptop computer, personal digital assistant (PDA), music player, gaming device, and/or or radar detector.

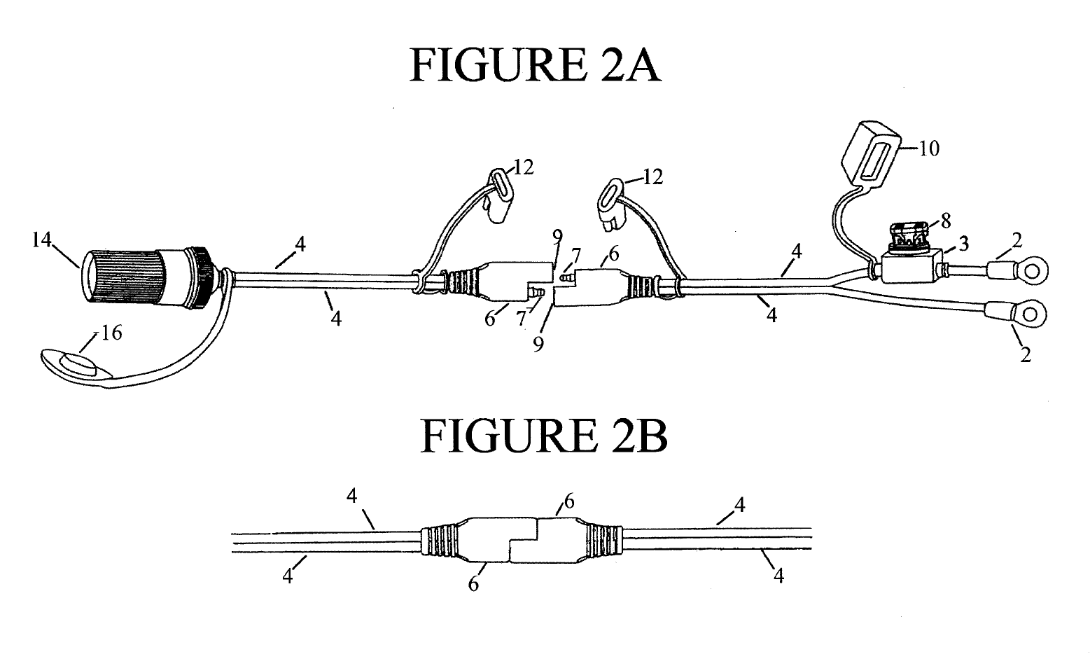

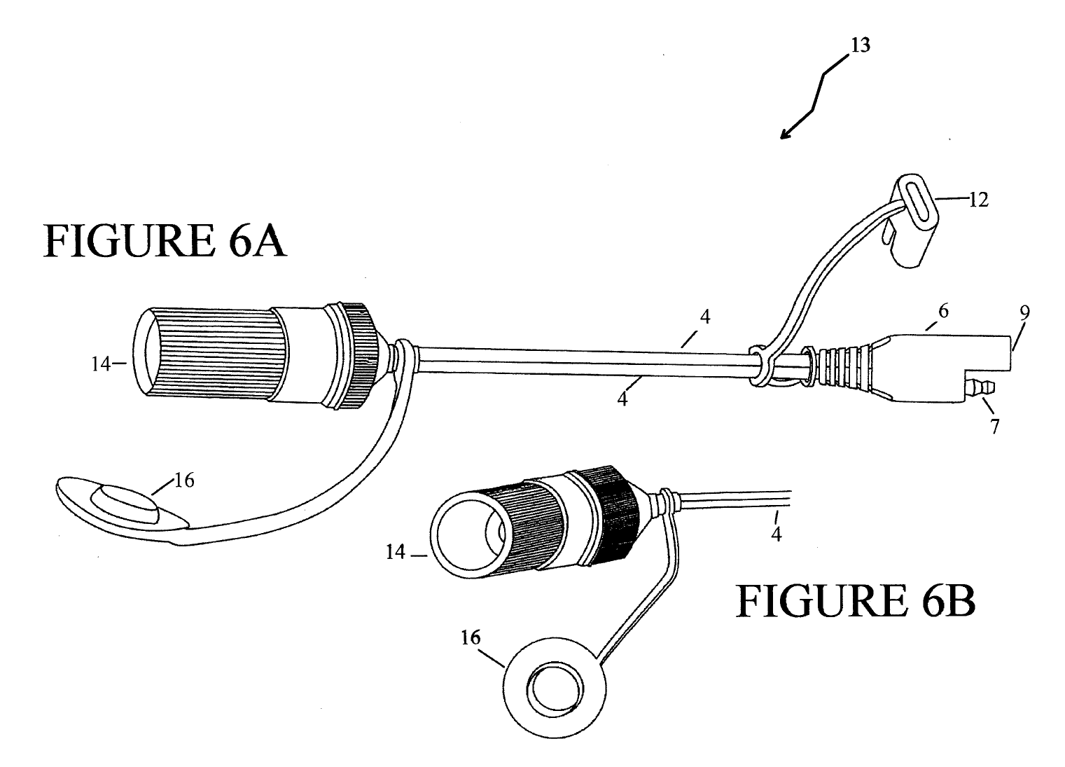

As shown in FIGS. 2, 6A and 6B, the double-pin quick connect 6 socket at the connecting end of the power adapting harness 1 may connect to a 12 volt power adapter socket 14 to receive a standard consumer electronic charger that would otherwise fit into a car cigarette lighter socket. Using this connection adaptor 13, a user can connect charging devices having a 12 volt cigarette connector end. The 12 volt adapter socket 14 may be covered with a weather proof cap 16. FIG. 2B depicts two double-pin quick connect 6 sockets connected together.

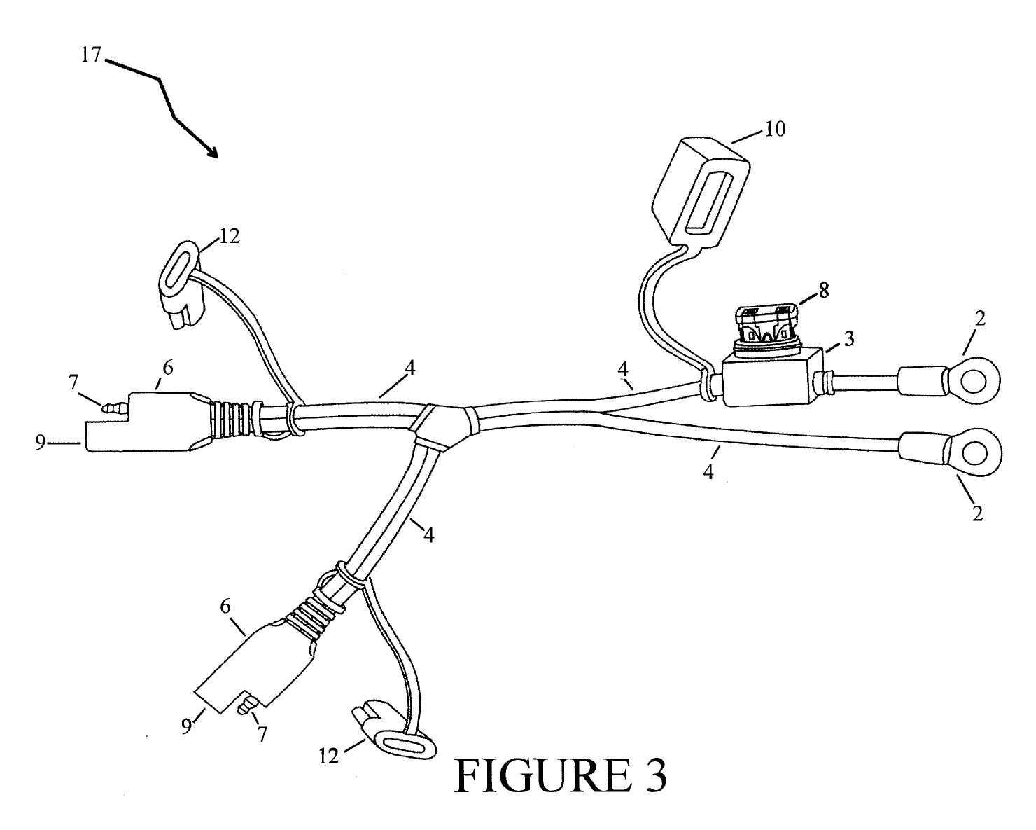

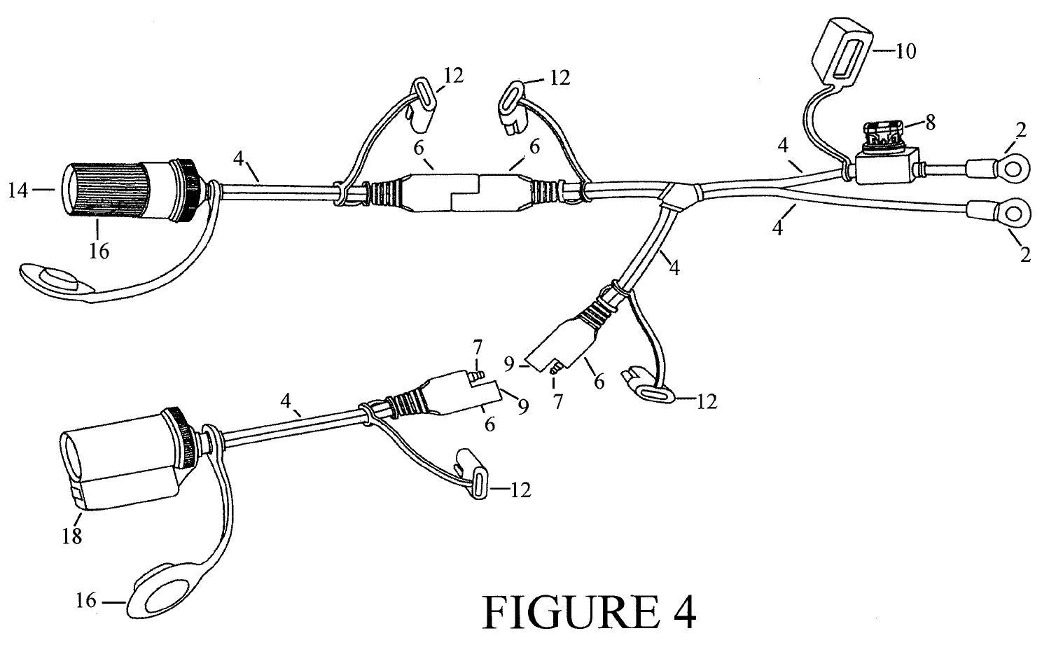

As shown in FIGS. 3 and 4, the power adapter charging harness may have a “Y” split to connect multiple electrical devices—a power adapter “Y” charging harness 17. The power adapter “Y” charging harness 17 consists of an in-line fuse holder 3, 8 but now contains two double-pin quick connect sockets 6. The power adapter “Y” harness 17 connects to any 12 volt battery the same as the power adapter charging harness 1.

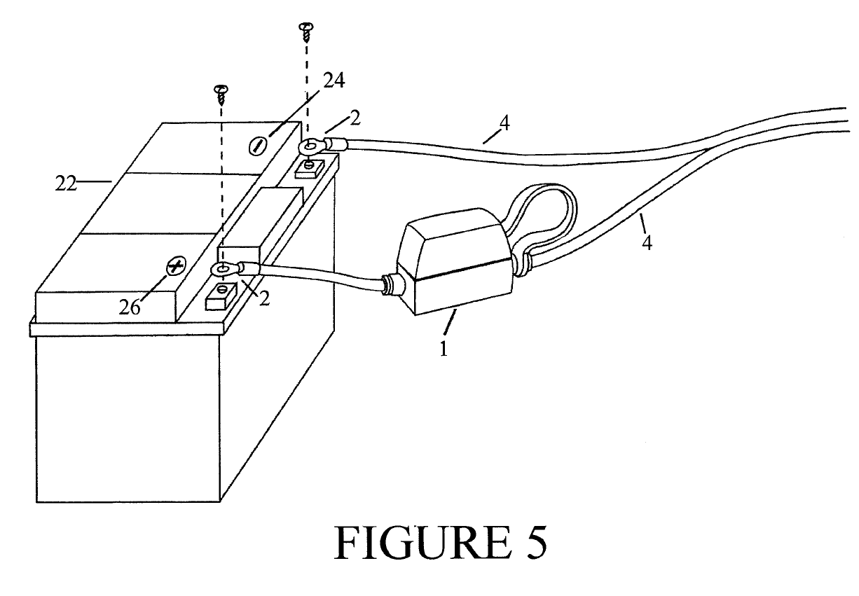

FIG. 5 depicts the power charging harness 1 connected to a 12 volt battery 22 using the two metal ring terminals 2 to connect to the positive 26 and negative 24 terminals of the battery 22.

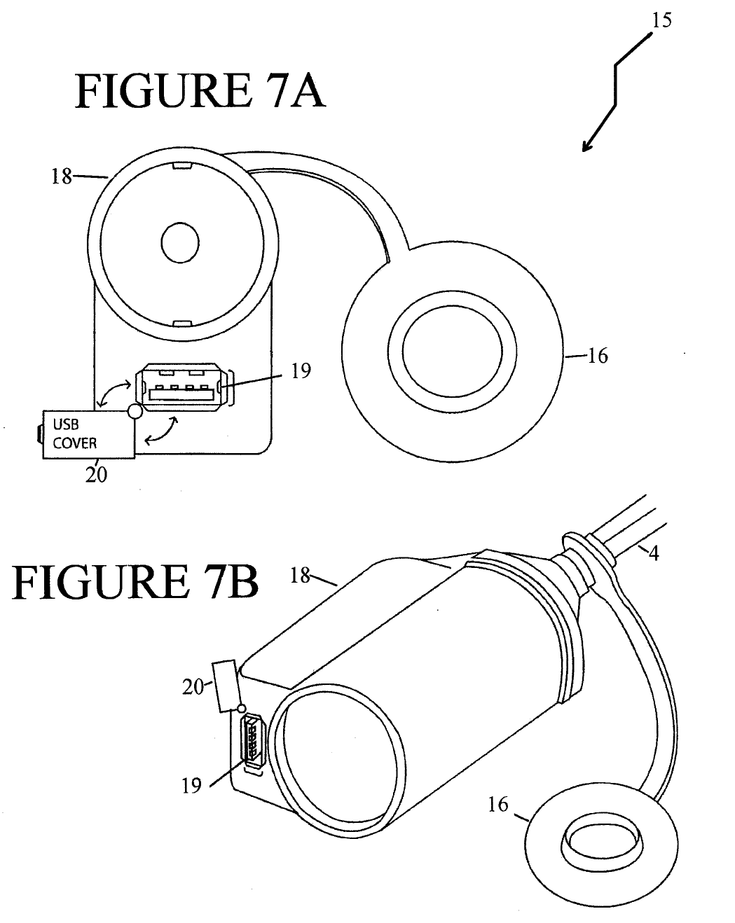

As shown in FIGS. 7A and 7B the 12 volt power adaptor socket 18 may have a USB port 19 connector. Using this connector unit 15, the user may connect electronic devices having a USB 19 connection. The 12 volt power adaptor socket 18 may be protected from dirt, dust and water using the attached weather proof cap 16. The USB port 19 may also be protected from dirt, dust and water using the USB cover 20. The 12 volt power adapting socket/USB port may be connected to the power adaptor harness 1 or the “Y” harness 17 using the double-pin quick connect sockets 6.

FIG. 8A depicts a bike-to-bike in-line jumper cable with double-pin quick connects 21. When combined with the power adaptor harness 1, this system eliminates the use of traditional alligator clip jumper cables 25, 32, 34 (FIG. 5) as long as both vehicles have the power adapter charging harness 1 installed on their battery 22 (FIG. 5). Using this system, the two ends of the double-pin quick socket 6 sockets into the charging harnesses 1 and it becomes an in line jumper cable.

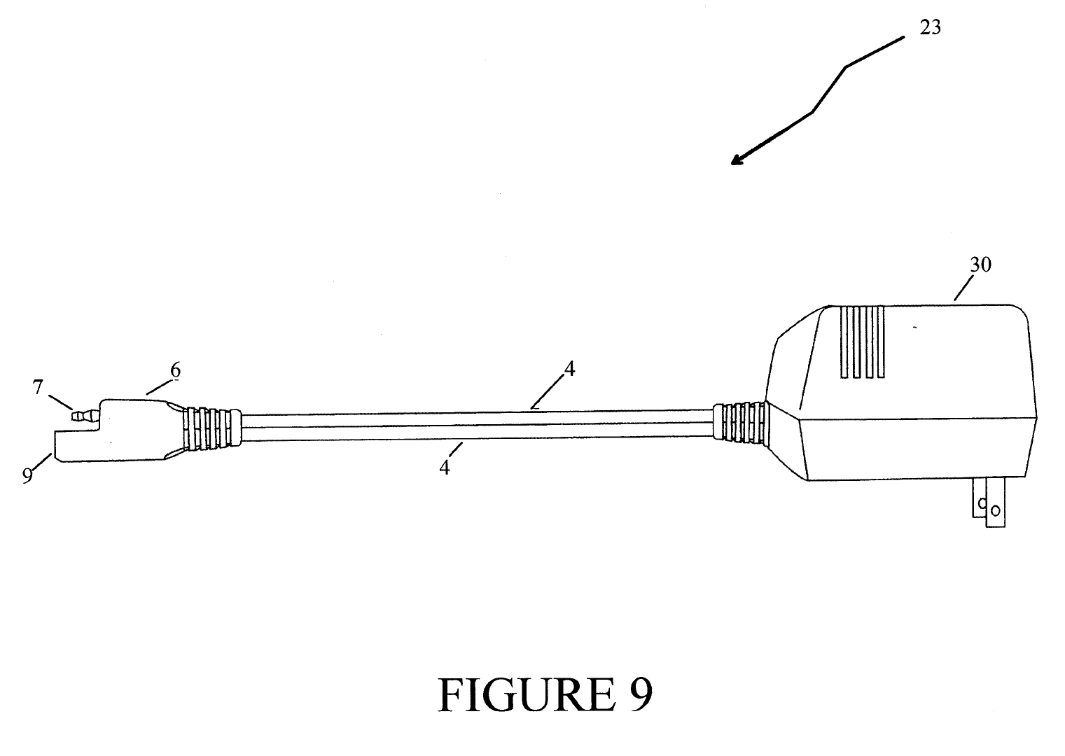

FIG. 9 is another embodiment of the invention wherein the power adaptor may be plugged into a traditional wall outlet. The wall battery charger 23 also comprises a double-pin quick connect socket 6 on the connecting end. The wall plug end 30 has an output of 12 volt D/C at 750 mA and an input of 115 volt A/C, at 60 Hz. The wire for the wall battery charger 23 is preferably comprised of 18-gauge wire 4. The length of the wire 4 is preferably at least feet long. The double-pin quick connect socket 6 plugs directly in to the power adapter charging harness 1 with in a line fuse holder 3, 8 allowing the electronic device to be fully charged by plugging it into a average 110 or 220 wall socket.

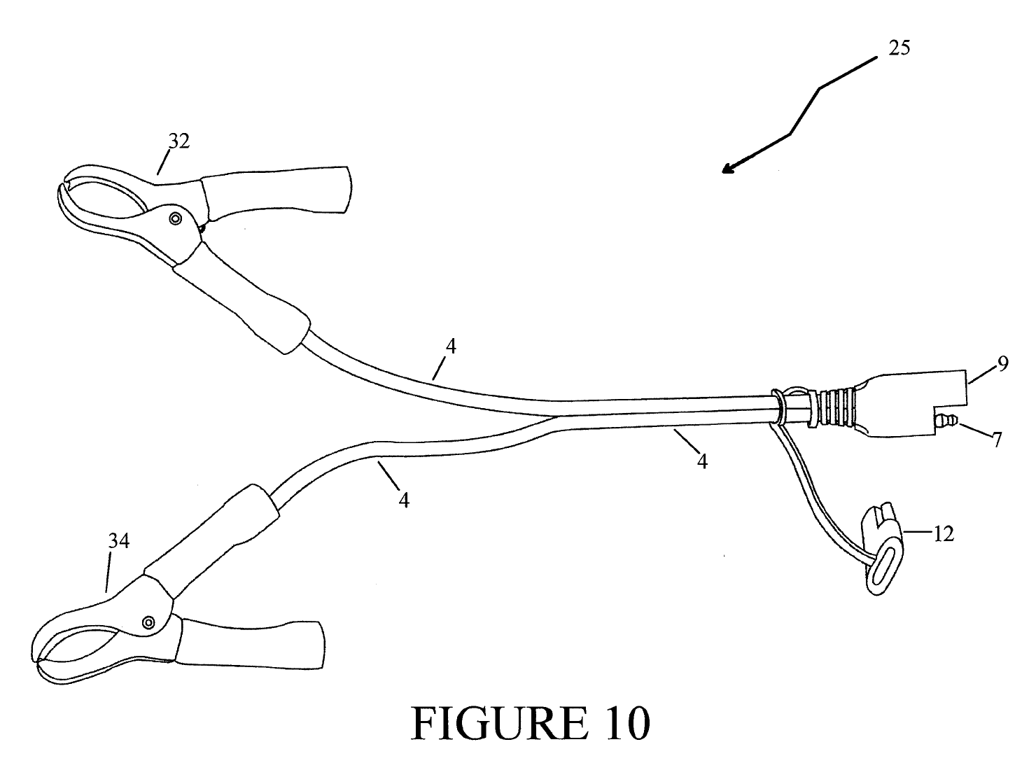

FIG. 10 demonstrates another embodiment of the invention wherein battery terminal clips 32, 34 may be used to connect to a 12 volt battery 22 and the double-pin quick connect socket 6 is combined with the power adaptor harness 1 or “Y” harness 17. This connection adaptor 25 allows the power adaptor harness 1 or “Y” harness 17 to act as jumper cables even when one vehicle does not have the double-pin quick connect harness present. The motorcycle, ATV, snowmobile, JetSki, or Scooter can be jump started by merely attaching the positive 32 and negative 34 clips to the battery terminals 24, 26 (FIG. 5) and the other end with the double-pin quick connect socket 6 plugging directly into the power adapter charging harness 1, or “Y” harness 17. The wire connector components 4 may be composed of 12-gauge, 14-gauge, 16-gauge, or 18-gauge wire. The connecting wire 4 may be between 2 feet and 6 feet in length.

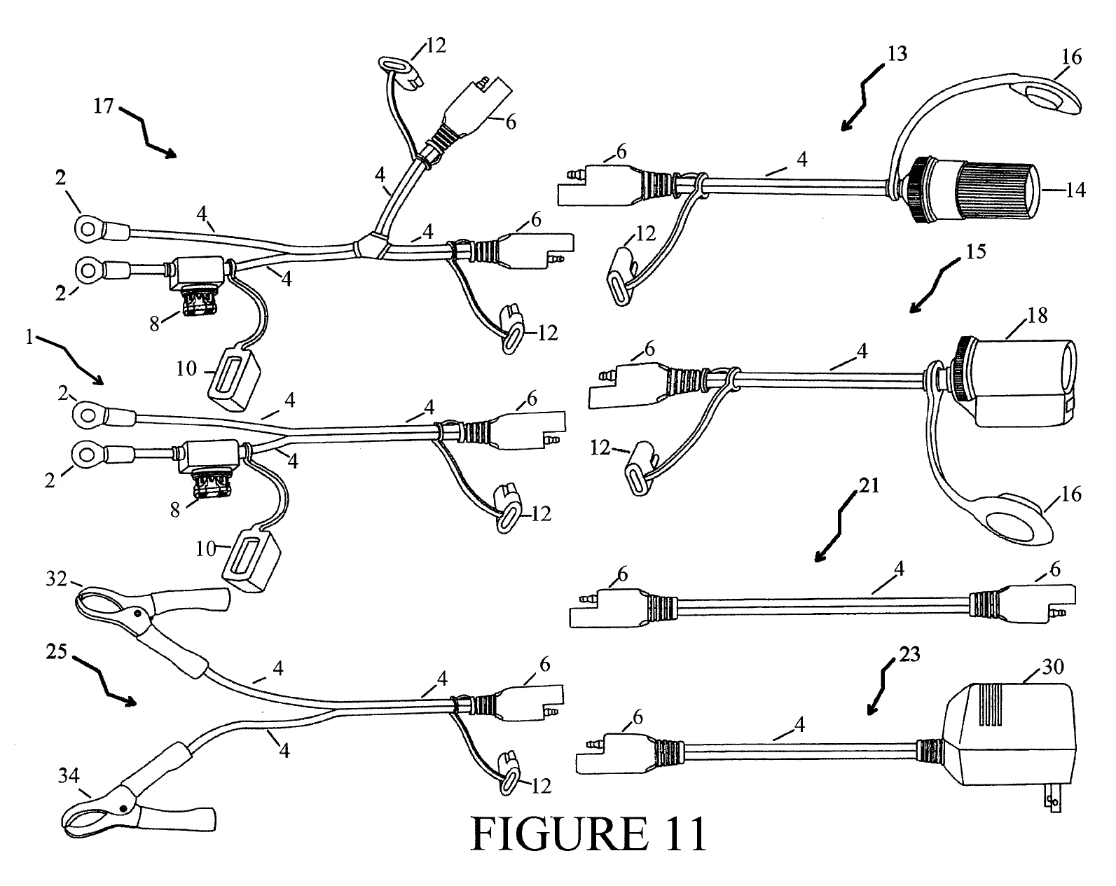

FIG. 11 presents the entire system of charging connector components 1, 13, 15, 17, 21, 23, and 25. This system of charging components and adaptors are an improvement over the prior art and allows a variety of charging options for numerous consumer electronic devices. This system also has the advantage of using the components to create a bike-to-bike battery jumping connection.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

I claim:

1. A portable power adaptor charging system comprising:
a) at least one wire having first and second ends;
b) said first end having at least one double-pin quick connect socket;
c) said second end having at least one terminal to connect to a power source; and
d) said wire having an in-line fuse and fuse housing.

2. The power adaptor charging system of claim 1, wherein a weather proof cap for the in-line fuse and fuse housing is attached to said wire.

3. The power adaptor charging system of claim 1, wherein at least one weather proof cap for at least one double-pin quick connect socket is attached to said wire.

4. The power adaptor charging system of claim 1, wherein said second end comprises two metal rings to connect to a 12 volt battery.

5. The power adaptor charging system of claim 1, wherein said second end comprises two metal clips to connect to a 12 volt battery.

6. The power adaptor charging system of claim 1, wherein said first end comprises at least two double-pin connector sockets.

7. The power adaptor charging system of claim 1, wherein said second end comprises a 12 volt power adaptor socket.

8. The power adaptor charging system of claim 1, wherein said second end comprises at least one 12 volt power adaptor socket having a USB port.

9. The power adaptor charging system of claim 1, wherein said second end comprises an AC/DC wall plug.

10. A portable power charging kit comprising three or more components selected from the group of components consisting of:
a) a connecting component having a first end with two metal clip connectors for electrical connection to a battery and a second end having at least one double-pin quick connect socket;
b) a connecting component having at least one double-pin quick connect socket at a first end, an in-line fuse, and at least two metal terminals at the second end for connection to a battery;
c) a connecting component having at least two double-pin quick connect sockets at a first end, an in-line fuse and fuse housing, and at least two metal terminals at the second end to connect to a battery;
d) a connecting component having a double-pin quick connect first end, and a double-pin quick connect second end;
e) a connecting component having a double-pin quick connect first end, and a 12 volt power adaptor socket at a second end;
f) a connecting component having a double-pin quick connect first end, and a second comprising a 12 volt power adaptor socket and a USB port; and
g) a connecting component having a double-pin quick connect first end, and an AC/DC wall plug at a second end.

11. The power adaptor charging system of claim 10, comprising at least four or more components selected from said group.

12. The power adaptor charging system of claim 11, comprising at least five or more components selected from said group.

13. The power adaptor charging system of claim 12, comprising at least six or more components selected from said group.

14. The power adaptor charging system of claim 13, comprising each of the components selected from said group.

15. A portable motorcycle battery charging system comprising:
a) a first connecting component having a first end with two metal clips to connect to a battery and a second end with at least one double-pin quick connect socket, and;
b) a second connecting component having a double-pin quick connect first end, an in-line fuse and fuse housing, and at least two metal terminals at the second end to connect to a battery.

16. The portable motorcycle charging system of claim 15, further comprising (c) a third connecting component having a wire having first and second ends with double-pin quick connect sockets at each end.
